(19) United States
(12) Patent Application Publication
(10) Pub. No.: US 2019/0040867 A1
(43) Pub. Date: Feb. 7, 2019

(54) HYDRAULIC ROTARY DRIVE

(71) Applicant: Poolstar Canada Limited, Woodbridge (CA)

(72) Inventor: Liang Chen, Woodbridge (CA)

(21) Appl. No.: 15/667,011

(22) Filed: Aug. 2, 2017

(51) Int. Cl. F04D 27/00; F04D 29/24; F04D 17/04; F04D 29/42; F03B 15/04

(52) U.S. Cl. CPC F04D 27/002; F04D 29/242; F03B 15/04; F04D 29/4293; F04D 17/04

(57) ABSTRACT

A hydraulic rotary drive includes a stator and an impeller rotatably connected to the stator. The stator has a liquid chamber defining a liquid inlet, a liquid outlet, and a flow circuit extending between the liquid inlet and the liquid outlet. The impeller is rotatably has a plurality of butterfly blades positioned in the flow circuit, and a rotation axis. Each butterfly blade extends radially away from the rotation axis, and includes first and second wings that are rotatable relative to each other about a radial axis between an open position and a closed position.

### FIELD

This application relates to the field of hydraulic rotary drives, and in particular to hydraulic rotary motors and pumps.

### INTRODUCTION

A hydraulic rotary drive is a device that exchanges energy between a flow of liquid (e.g. water) and an impeller. For example, a hydraulic rotary drive can be a motor that uses energy from a liquid flow to drive mechanical rotation of an impeller, or a pump that uses mechanical rotation of an impeller to drive a liquid to flow.

### SUMMARY

In one aspect, a hydraulic rotary drive is provided. The hydraulic rotary drive may include a stator having a liquid chamber defining a liquid inlet, a liquid outlet, and a flow circuit extending between the liquid inlet and the liquid outlet; and an impeller rotatably connected to the stator, the impeller having a plurality of butterfly blades positioned in the flow circuit, and a rotation axis. Each butterfly blade may extend radially away from the rotation axis, and include first and second wings that are rotatable relative to each other about a radial axis between an open position and a closed position.

In another aspect, an impeller for a hydraulic rotary drive is provided. The impeller may include a plurality of butterfly blades extending radially away from a rotation axis and circumferentially spaced apart. Each butterfly blade may include first and second wings that are rotatable about a radial axis between an open position and a closed position.

### DRAWINGS

FIG. 1 is a front perspective view of a hydraulic rotary drive in accordance with an embodiment;

FIG. 2 is a rear perspective view of the hydraulic rotary drive of FIG. 1;

FIG. 3 is a front perspective view of the hydraulic rotary drive of FIG. 1 with an upper stator shell removed;

FIG. 4 is an exploded perspective view of the hydraulic rotary drive of FIG. 1;

FIG. 5 is a front elevation view of the hydraulic rotary drive of FIG. 1 showing an impeller and a lower stator shell; and

FIG. 6 is a front perspective view of the stator of the hydraulic rotary drive of FIG. 1 with the upper stator shell removed.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined” or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, or “directly fastened” where the parts are connected in physical contact with each other. As used herein, two or more parts are said to be “rigidly coupled”, “rigidly connected”, “rigidly attached”, “rigidly joined”, or “rigidly fastened” where the parts are coupled so as to move as one while maintaining a constant orientation relative to each other. None of the terms “coupled”, “connected”, “attached”, “joined”, and “fastened” distinguish the manner in which two or more parts are joined together.

As used herein and in the claims, a first element is said to be “received” in a second element where at least a portion of the first element is received in the second element unless specifically stated otherwise.

As used herein and in the claims, a first element is said to be “transverse” to a second element where the elements are oriented within 45 degrees of perpendicular to each other.

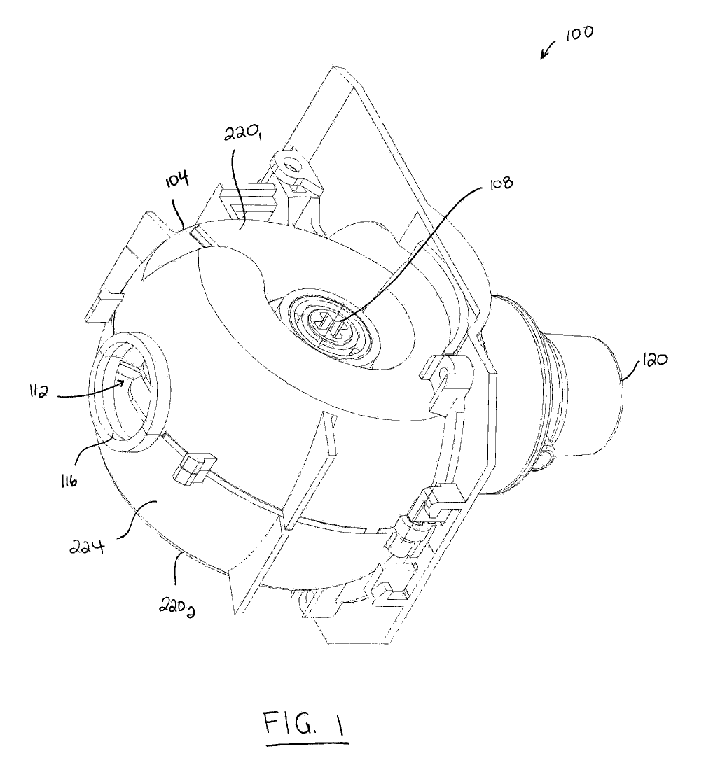

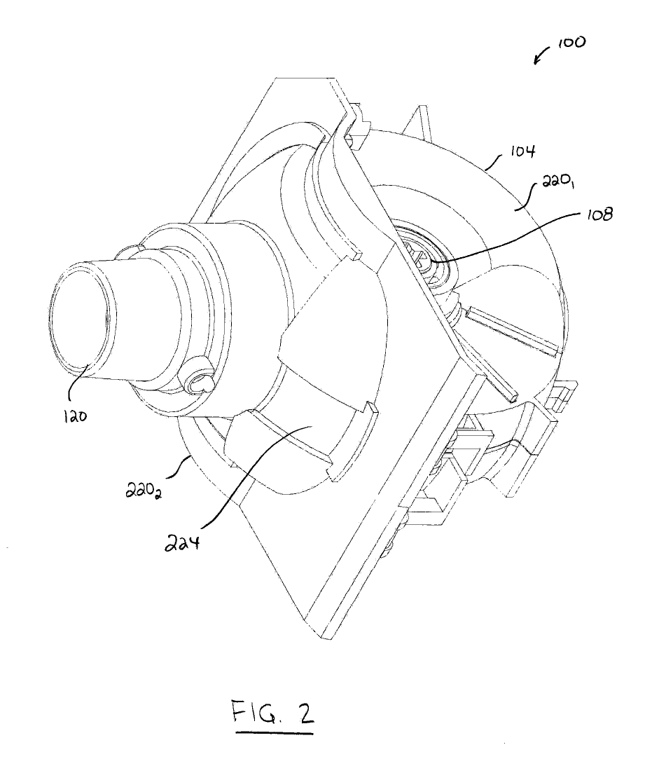

Reference is made to FIGS. 1-2, which show a hydraulic rotary drive 100 in accordance with an embodiment. As shown, hydraulic rotary drive 100 includes a stator 104 and an impeller 108. Impeller 108 is rotatably connected to stator 104. Stator 104 houses impeller 108 in a liquid chamber 112. Liquid chamber 112 has liquid ports 116 and 120. One of liquid ports 116 and 120 is a liquid inlet, and the other of ports 116 and 120 is an outlet. The designation of which port 116 and 120 is an inlet or an outlet depends on whether hydraulic rotary drive 100 is operating as a motor or a pump. For clarity of illustration, a motor configuration is described below as the primary example, whereby port 116 may be referred to as a liquid inlet and port 120 may be referred to as a liquid outlet.

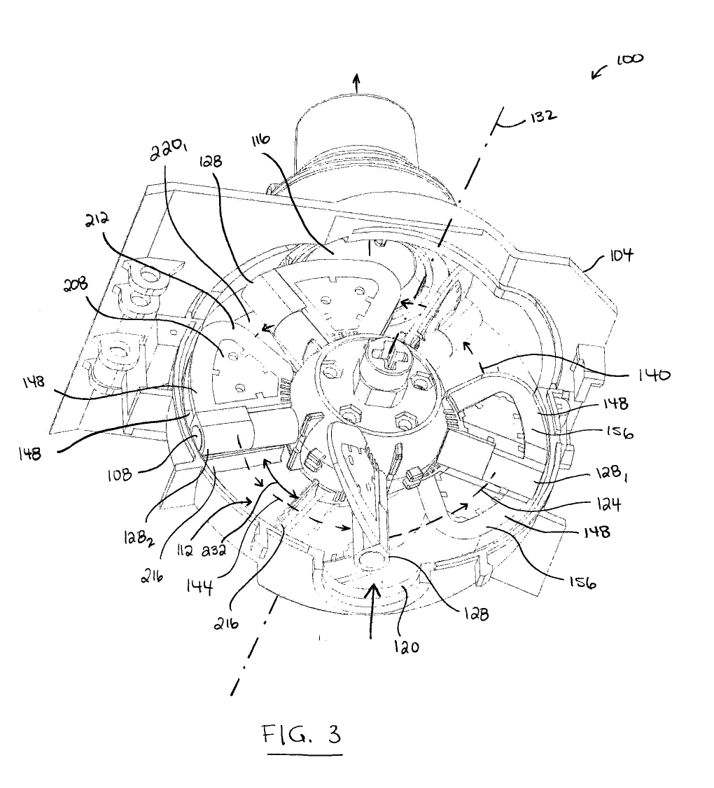

As shown in FIG. 3, liquid chamber 112 defines a liquid circuit 124 that extends from liquid inlet 116 to liquid outlet 120, and back to liquid inlet 116. Liquid circuit 124 places liquid inlet 116 in fluid communication with liquid outlet 120 whereby fluid entering liquid chamber 112 can flow across liquid circuit 124 and exit through liquid outlet 120. Impeller 108 includes a plurality of butterfly blades 128 positioned within liquid circuit 124. Impeller 108 is rotatably connected to stator 104 according to a rotation axis 132. Rotation of impeller 108 about rotation axis 132 relative to stator 104 moves butterfly blades 128 along liquid circuit 124. Butterfly blades 128 interact with the liquid flow in flow circuit 124 to exchange energy between the liquid flow and mechanical rotation of impeller 108. When operating as a motor, the liquid flow applies force onto butterfly blades 128 as the liquid moves from liquid inlet 116 to liquid outlet 120 to thereby rotate impeller 108 about rotation axis 132. The mechanical rotation of impeller 108 may be output to a drive shaft (not shown) connected to impeller 108.

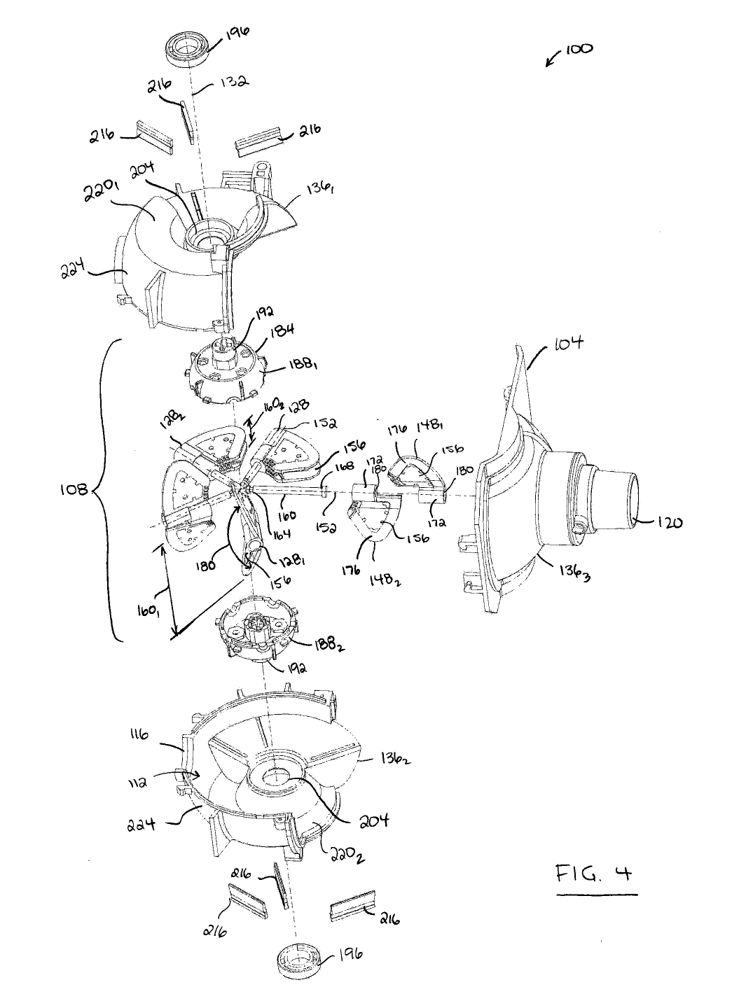

Referring to FIG. 4, stator 104 can have any construction that defines a liquid chamber, inlet, and outlet suitable for directing a flow of liquid that can exchange energy with impeller 108. In the illustrated example, stator 104 includes a plurality of stator shells 136 that combine to form liquid chamber 112 and define ports 116 and 120. As shown, stator 104 may include an upper shell 136₁, a lower shell 136₂, and an outlet shell 136₃. In other embodiments, stator 104 may include greater or fewer shells 136. For example, stator 104 may be formed of a single monolithic shell.

Shells 136 may be assembled with impeller 108 positioned inside, as shown. Shells 136 may be permanently connected or removably connected to each other. A removably connection may permit shells 136 to be disassembled for access to liquid chamber 112 and impeller 108. This may allow liquid chamber 112 to be cleared of debris, and allow impeller 108 to be cleaned, repaired, and replaced as may be required by the circumstances.

Still referring to FIG. 4, shells 136 may be made of any material suitable for forming liquid chamber 112. For example, shells 136 are made of a liquid (e.g. air and/or liquid) impermeable material, such as plastic or metal. A substantially rigid shell material may provide a liquid chamber 112 that can retain its shape against the liquid pressures within. A hard plastic or metal shell material may be used. In some embodiments, at least a portion of stator 104 may be made of transparent material. For example, one or more (or all) of shells 136 may include transparent material that can allow a user to have visibility into liquid chamber 112. This can allow the user to visually determine whether there is debris lodged in liquid chamber 112, or if an impeller component is damaged, without having to disassemble stator 104.

Returning to FIG. 3, liquid circuit 124 has a forward flowpath 140 and a return flowpath 144. Forward flowpath 140 extends from liquid inlet 116 to liquid outlet 120, and return flowpath 144 extends from liquid outlet 120 back to liquid inlet 116. In use, as impeller 108 rotates about rotation axis 132, butterfly blades 128 move from liquid inlet 116 along forward flowpath 140 to liquid outlet 120, exchanging energy with the liquid flowing from liquid inlet 116 to liquid outlet 120. Afterwards, butterfly blades 128 return to liquid inlet 116 along return flowpath 144.

The energy transfer efficiency of hydraulic rotary drive 100 between the liquid flow and the impeller 108 depends largely on a difference in tangential force (also referred to as ‘rotary force’) applied by/to the butterfly blades 128 in the forward flowpath 140 compared to the return flowpath 144. Specifically, energy transfer efficiency is improved by increasing the ratio of tangential force on butterfly blades 128 in the forward flowpath 140 to the tangential force on butterfly blades 128 in the return flowpath 144. One or both of stator 104 and impeller 108 may be configured to provide improved energy transfer efficiency.

Turning now to FIG. 4, each butterfly blade 128 includes first and second wings 148₁ and 148₂. Wings 148₁ and 148₂ are rotatable relative to each other about a respective radial axis 152 between a closed position and an open position. As shown, each wing 148 has a liquid drive surface 156 which interacts with the liquid flow to exchange energy between the liquid flow and the impeller 108. For example, liquid drive surfaces 156 apply force to the liquid flow when hydraulic rotary drive 100 is operating as a pump, and the liquid flow applies force to liquid drive surfaces 156 to rotate impeller 108 when hydraulic rotary drive 100 is operating as a motor.

Returning to FIG. 3, as impeller 108 rotates about rotation axis 132, each butterfly blade 128 travels continuously along flow circuit 124, alternating between the forward flowpath 140 and the return flowpath 144. Butterfly blades 128 are moved to the open position in the forward flowpath 140 whereby liquid drive surfaces 156 are oriented to promote energy exchange with the liquid flow. Conversely, butterfly blades 128 are moved to the closed position in the return flowpath 144 whereby liquid drive surfaces 156 are oriented to reduce or inhibit energy exchange with the liquid flow.

Referring to FIGS. 3 and 4, butterfly blade 128₁ is shown positioned in the forward flowpath 140 with wings 148 in an open position, and butterfly blade 128₂ is shown positioned in the return flowpath 144 with wings 148 in a closed positioned. As shown, the closed position provides butterfly blade 128₂ with a lesser height 160₂ and tangential projection area than butterfly blade 128₁ in the open position.

For clarity, a tangential projection area is an area measurement of a tangential projection of the butterfly blade 128 (i.e. a projection of the butterfly blade 128 tangential to the rotation about rotation axis 132). For example, if butterfly blade 128 was a sphere, then the tangential projection area would be equal to the area of the circular projection of the sphere (A_{tang}=πr², where r is a radius of the sphere) as opposed to a surface area of the sphere. The rotary force (i.e. tangential component of force) on butterfly blade 128, which drives impeller 108 to rotate about rotation axis 132 when operated as a motor, is proportional to the tangential projection area of the butterfly blade 128.

Butterfly blades 128 can have any closed position height 160₂ less than open position height 160₁, which is suitable for efficient energy exchange between butterfly blades 128 and the liquid flow. For example, the closed position height 160₂ may be less than one quarter of the open position height 160₁. Similarly, butterfly blades 128 can have any closed position tangential projection area less than the open position tangential projection area, which is suitable for efficient energy exchange between butterfly blades 128 and the liquid flow. For example, the closed position tangential projection area may be less than one quarter of the open position tangential projection area.

Turning to FIG. 4, wings 148 of each butterfly blade 128 can be connected in any manner that allows for relative rotation about radial axis 152 between open and closed positions. In the illustrated example, each butterfly blade 128 includes an axle 160 having a proximal portion 164 and a distal portion 168. Wings 148 may be rotatably mounted to axle 160. As shown, axle 160 may be collinear with radial axis 152, and wings 148 may be mounted to rotate around axle 160. For example, each wing 148 may extend from a proximal portion 172 rotatably mounted to axle 160 to a distal portion 176. Proximal portion 172 may be connected to axle 160 in any manner that allows the wing 148 to rotate about radial axis 152 between the open and closed positions. In the illustrated example, proximal portion 172 includes a sleeve 180 that receives axle distal portion 168.

Wings 148 of a butterfly blade 128 may be rotatable around radial axis 152 by any angle relative to each other to form an angle 180. In the open position liquid drive surfaces 156 of wings 148 may form an open angle 180 that may be between 90-240 degrees. In the closed position, liquid drive surfaces 156 of wings 148 may form an angle 180 that may be between 0 and 60 degrees. The difference in angle 180 between an open butterfly blade 180₁ and a closed butterfly blade 180₂ can provide a great difference in the height and tangential projection areas between the open and closed positions for greater energy transfer efficiency. In the illustrated example, the open angle 180 is about 170 degrees, and closed angle 180 is about 0 degrees (parallel liquid drive surfaces 156).

Still referring to FIG. 4, the wings 148 of a butterfly blade 128 may be mounted in any manner that restricts their relative rotation to between the open and closed positions. For example, the relative shapes of blade axle 160 and sleeve 180 may be such as to create an interference that inhibits rotation beyond the open and closed positions. Alternatively or in addition, mutual interference between the two wings 148 may prevent each wing 148 from rotating beyond the open and closed positions.

As shown, the two wings 148 of a butterfly blade 128 rotate in opposite rotational directions about radial axis 152 (i.e. clockwise or counterclockwise) relative to each other when moving to the open and closed positions. In the closed position, the two wings 148 of a butterfly blade 128 may overlay each other in a folded configuration. As shown, the liquid drive surfaces 156 of the two wings 148 may overlay each other, and face each other when in the closed position. In the closed position, the two wings 148 may extend rearwardly of the radial axis 152 (e.g. upstream when operated as a motor). For example, both wings 148 may be substantially parallel to a plane normal to the rotation axis 132. To move to the open position, the two wings 148 of a butterfly blade 128 may rotate in opposite rotational directions around radial axis 152, away from each other. For example, both wings 148 may rotate forwardly (e.g. downstream when operated as a motor) from the closed position to the open position.

The butterfly blades 128 of impeller 108 may be connected together in any manner that allows butterfly blades 128 to rotate in unison about rotation axis 132. In the illustrated example, the axle proximal portions 164 of butterfly blades 128 are joined to a common impeller hub 184. Impeller hub 184 may be centrally located at rotation axis 132, and rotate with butterfly blades 128 about rotation axis 132.

Impeller hub 184 can have any construction that allows impeller hub 184 to join butterfly blades 128 together and rotatably connect butterfly blades 128 to stator 104. In the illustrated example, impeller hub 184 includes an upper hub portion 188₁ and a lower hub portion 188₂. Hub portions 188 may be removably connected as shown, or permanently connected. A removable connection between hub portions 188 can allow hub portions 188 to be separated to remove, repair, or replace a connected butterfly blade 128. In other embodiments, impeller hub 184 may have a single monolithic impeller hub portion, or may have greater than two impeller hug portions.

Impeller hub 184 may be connected to stator 104 in any manner that allows the connected butterfly blades 128 to rotate about rotation axis 132. In the illustrated example, each hub portion 188 includes a mounting member 192 that is rotatably connected to stator 104. As shown, mounting members 192 may be formed as mounting lugs (also referred to as mounting protrusions) which are connected to stator 104 by way of a bearing 196. Mounting members 192 and bearings 196 may be received in respective mounting apertures 204 of stator end wall 220 as shown. In the illustrated example, mounting members 192 and bearings 196 are aligned centered on rotation axis 132.

Referring to FIG. 3, impeller 108 can have any number of butterfly blades 128 suitable for exchanging energy with liquid flow passing through stator 104. Preferably impeller 108 has at least two butterfly blades 128 so that at all times at least one of the butterfly blades 128 is positioned in forward flowpath 140 to exchange energy with the liquid flow. For example, impeller 108 may have 3-50 butterfly blades. In the illustrated example, impeller 108 has 5 butterfly blades 128.

Wings 148 can have any shape suitable for exchanging energy with liquid flow through stator 104. In the illustrated example, wings 148 are shaped so that when the butterfly blade 128 is in an open position, butterfly blade 128 substantially obstructs liquid flow through forward flowpath, and when butterfly blade 128 is in a closed position, butterfly blade 128 substantially obstructs liquid flow through return flowpath 144. For example, the two wings 148 of a butterfly blade 128 may be shaped such that when in an open position, the two butterfly blades 128 together correspond to the cross-sectional shape of the forward flowpath 140. Both wings 148 may have substantially the same shape as shown, or may have different shapes. In the illustrated example, wings 148 have a round-edged triangular shape. In other embodiments, wings 148 may have a rectangular or semi-circular shape, or another regular or irregular shape.

Wings 148 can be made of any material suitable for exchanging energy with liquid flow passing through stator 104. For example, wings 148 may be made of liquid-impermeable material and may be free of apertures (i.e. holes) so that force is efficiently applied to/by wings 148. Wings 148 may include rigid and/or flexible materials. For example, wings 148 may include an inner portion 208 of rigid material (e.g. rigid plastic or metal) which can retain its shape against high liquid pressures, and an outer portion of flexible material (e.g. flexible plastic or rubber). Flexible outer portion 212 may surround at least a portion of wing inner portion 208. Flexible outer portion 212 may be sufficiently flexible to allow debris to pass, which might otherwise jam impeller 108.

The energy transfer efficiency of hydraulic rotary drive 100 may be improved by reducing liquid forces and liquid flow across return flowpath 144. For example, when operated as a motor, liquid forces acting on impeller 108 in return flowpath 144 may act in opposition to liquid forces acting on impeller 108 in forward flowpath 140; and when operated as a pump, liquid flow that diverts to return flowpath 144 requires additional energy for that liquid to recirculate across forward flowpath 140 to the liquid outlet.

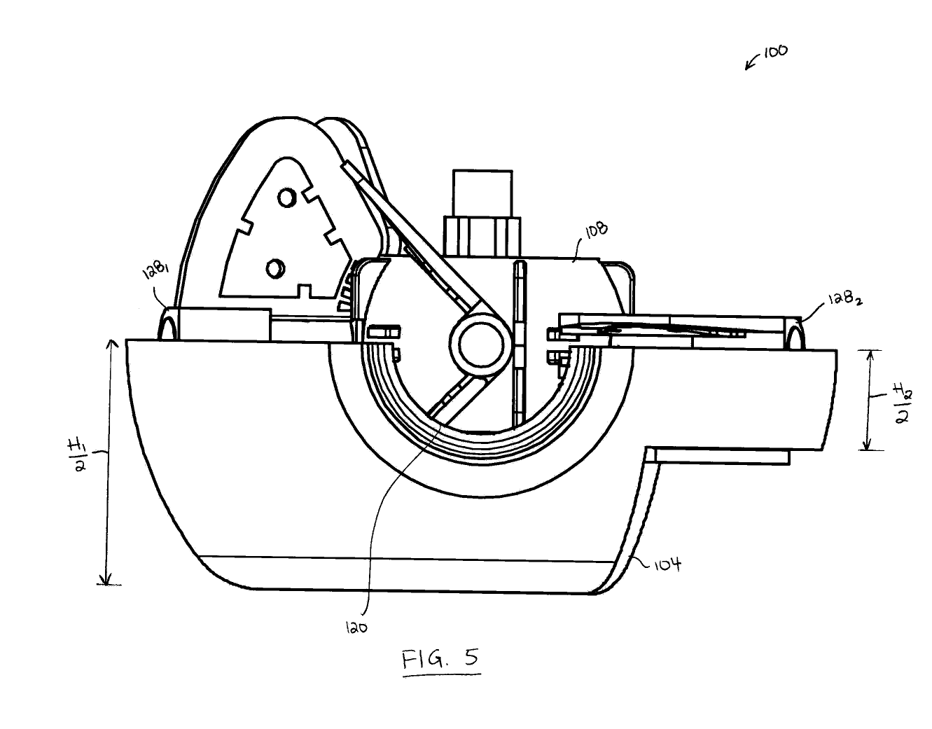

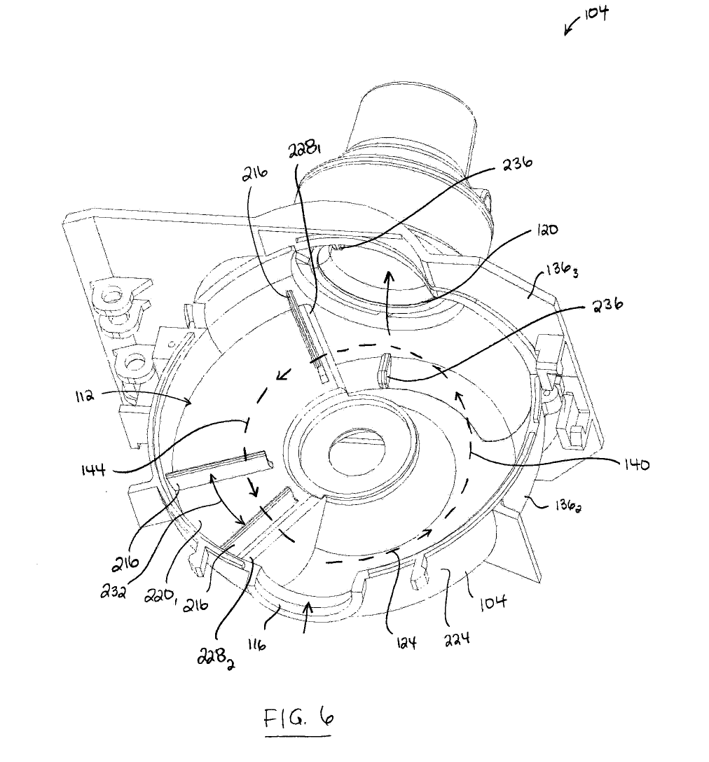

Reference is now made to FIGS. 5-6, which show stator 104 with the upper stator shell removed. In this example, approximately the lower half of flow circuit 124 is shown, and the upper half may be substantially symmetrical with the lower half shown. In some embodiments, stator 104 may be configured to reduce liquid forces and liquid flow across return flowpath 144. As shown, forward flowpath 140 may have a large cross-sectional area and height H₁ to accommodate open position butterfly blades 128₁, and return flowpath 144 may have a smaller cross-sectional area and height H₂ to accommodate closed position butterfly blades 128₂. In some embodiments, return flowpath 144 may have a cross-sectional area that is less than one quarter that of forward flowpath 140. In some embodiments, return flowpath 144 may have a height H₂ that less than one quarter of forward flowpath height H₁.

Return flowpath 144 may have a lower total volume than forward flowpath 140. The lower volume of return flowpath 144 compared to forward flowpath 140 reduces the volumetric rate of liquid that flows across the return flow path 144 compared to the forward flowpath 140. The net volume of liquid within return flowpath 144 is equal to the volume of return flowpath 144 less the occupying volume of butterfly blade(s) 128 within return flowpath 144. All else being equal, a return flowpath 144 with less net volume (i.e. that more closely conforms to the closed butterfly blade(s) 128 within the flowpath 144) has less liquid capacity (i.e. lower net volume for liquid), and therefore carries less liquid.

Flow circuit 124 can have any path shape that allows liquid to move between liquid inlet 116 and liquid outlet 120, and that allows butterfly blades 128 to circulate continuously between liquid inlet 116 and liquid outlet 120. In the illustrated example, flow circuit 124 has a circular path shape. In other embodiments, flow circuit 124 may have a triangular, square, or other regular or irregular path shape.

Within flow circuit 124, there can be any spacing between liquid ports 116 and 120 that allows for a transfer of energy between impeller 108 and the liquid flow. In the illustrated example, liquid ports 116 and 120 are 180 degrees apart. As shown, liquid ports 116 and 120 may have a parallel alignment (e.g. collinear alignment). Providing parallel flow vectors at the inlet and outlet may help to reduce net turbulence (and consequent energy losses) in the liquid flow. In other embodiments, liquid ports 116 and 120 may be differently spaced apart. For example, forward flowpath 140 may extend across 90 to 270 degrees of flow circuit 124, and liquid inlet and outlet 116 and 120 may face different directions.

Referring to FIGS. 1 and 2, stator 104 may include upper and lower end walls 220₁ and 220₂ which are peripherally connected by a stator sidewall 224. Referring to FIGS. 3 and 6, stator 104 may include one or more projections 216 (e.g. fins) that extend inwardly from stator end wall 220 into return flowpath 144. Projections 216 may include a resiliently flexible material (e.g. flexible plastic or rubber, or bristles) so as to allow passage of debris across return flowpath 144 and thereby mitigate jamming, and/or to wipe/brush butterfly blades 128 to remove any dirt or debris. Projections 216 may also act to reduce the effective height, cross-sectional area, and liquid capacity of return flowpath 144. In particular, liquid bordered by a projection 216 between butterfly blades 128 and stator end wall 220 may be substantially trapped and stagnant.

Stator 104 can include any number of projections 216. For example, stator 104 may include just one projection 216 per end wall 220 (e.g. positioned at one end 228₁ or 228₂ of return flowpath 144), or a plurality of projections 216 per end wall 220. Referring to FIG. 4, in the illustrated example, stator 104 is shown including six projections 216 (three per end wall 220). One projection 216 per end wall 220 is shown positioned at each end 228 of return flowpath 144, and a third projection 216 per end wall 220 is shown positioned between the end projections 216. Projections 216 may be removably connected to stator 104 as shown, or permanently connected. A removable connection may permit projections 216 to be removed for repair, cleaning, or replacement as the circumstances require.

Returning to FIGS. 3 and 6, in some embodiments, a spacing 232 between two adjacent projections 216 of an end wall 220 may be sized so that a single butterfly blade 128 can overlie both projections 216 simultaneously. This may help to further stagnate the flow of liquid trapped between the butterfly blades 128, end wall 220, and the two adjacent projections 216. Alternatively or in addition, projections 216 of an upper end wall 220₁ (FIG. 1) and projections 216 of lower end wall 220₂ may be substantially aligned (i.e. identically positioned along return flowpath 144) as shown in FIG. 4. This may provide a choke point sized to permit passage of a closed butterfly blade 128 and to inhibit flow of liquid around the butterfly blade 128.

Referring to FIGS. 3 and 6, in some embodiments, butterfly blades 128 may at least begin to close and open automatically by differential pressures within flow circuit 124. For example, at liquid outlet 120 the flow of exiting liquid may draw wings 148 of a passing butterfly blade 128 rearwardly towards the closed position. Conversely, at liquid inlet 116, the flow of entering liquid may force wings 148 of a passing butterfly blade 128 forwardly towards the open position.

In some embodiments, stator 104 may act upon butterfly blades 128 to move butterfly blades 128 to the closed position. As shown, stator end wall 220 may diverge axially inwardly (i.e. towards a midplane of hydraulic rotary drive 100 along the rotation axis 132) at return flowpath end 228₁ proximate liquid outlet 120. As butterfly blades 128 enter return flowpath 144, stator end wall 220 at return flowpath end 228₁ may strike their wings 148 forcing the wings 148 rearwardly to the closed position. In some embodiments, this striking may be reduced or avoided by initiating the close of butterfly blades 128 upstream of return flowpath end 228₁. For example, stator 104 may include projections 236 which extend from stator end walls 220₁ and 220₂ proximate liquid outlet 120 into forward flowpath 140. Projections 236 may be sized to strike wing outer portions 212 urging wings 148 to rotate rearwards towards the closed position. This initiation of the blade closure in combination with the closing influence of the flow exiting outlet 120 may reduce or avert wings 148 striking stator end wall 220 at return flowpath end 228₁. This may mitigate damage to wings 148 from striking stator end wall 220 and thereby prolong the lifespan of butterfly blades 128.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1. A hydraulic rotary drive comprising:
a stator having a liquid chamber defining a liquid inlet, a liquid outlet, and a flow circuit extending between the liquid inlet and the liquid outlet; and
an impeller rotatably connected to the stator, the impeller having a plurality of butterfly blades positioned in the flow circuit, and a rotation axis,
wherein each butterfly blade extends radially away from the rotation axis, and includes first and second wings that are rotatable relative to each other about a radial axis between an open position and a closed position.

Item 2. The hydraulic rotary drive of item 1, wherein:
each of the first and second wings has a liquid drive surface,
in the open position, the liquid drive surfaces of the first and second wings is oriented to promote energy exchange with liquid in the flow circuit, and
in the closed position, the liquid drive surfaces of the first and second wings is oriented to inhibit energy exchange with liquid in the flow circuit.

Item 3. The hydraulic rotary drive of any one of items 1-2, wherein:
in the open position, each butterfly blade has a first height parallel to the rotation axis, and
in the closed position, each butterfly blade has a second height parallel to the rotation axis and that is less than the first height.

Item 4. The hydraulic rotary drive of item 3, wherein:
the second height is less than one quarter of the first height

Item 5. The hydraulic rotary drive of any one of items 1-4, wherein:
in the open position, each butterfly blade has a first tangential projection area, and
in the closed position, each butterfly blade has a second tangential projection area that is less than the first tangential projection area.

Item 6. The hydraulic rotary drive of item 5, wherein:
the second tangential projection area is less than one quarter the first tangential projection area.

Item 7. The hydraulic rotary drive of any one of items 1-6, wherein:
the flow circuit has a forward flowpath extending from the liquid inlet to the liquid outlet, and a return flowpath extending from the liquid outlet to the liquid inlet,
measured parallel to the rotation axis, a height of the return flowpath is less than a height of the forward flowpath.

Item 8. The hydraulic rotary drive of any one of items 1-6, wherein:
the flow circuit has a forward flowpath extending from the liquid inlet to the liquid outlet, and a return flowpath extending from the liquid outlet to the liquid inlet,
a cross-sectional area of the return flowpath is less than a cross-sectional area of the forward flowpath.

Item 9. The hydraulic rotary drive of any one of items 1-8, wherein:
a volume of the return flowpath is less than a volume of the forward flowpath.

Item 10. The hydraulic rotary drive of any one of items 7-9, wherein:
the stator includes a plurality of fins that protrude into the return flowpath of the flow circuit.

Item 11. The hydraulic rotary drive of item 10, wherein:
each fin has a resiliently flexible distal edge.

Item 12. The hydraulic rotary drive of any one of items 1-8, wherein:
the impeller includes a hub that intersects the rotation axis, and
each butterfly blade includes an axle extending from a proximal axle portion to a distal axle portion, the proximal axle portion mounted to the hub, and the first and second wings rotatably mounted to the distal axle portion.

Item 13. The hydraulic rotary drive of any one of items 1-11, wherein:
the flow circuit is circular and centered around the rotation axis.

Item 14. The hydraulic rotary drive of item 12, wherein:
the liquid inlet is spaced 180 degrees apart from the liquid outlet.

Item 15. The hydraulic rotary drive of any one of items 1-14, wherein:
the first and second wings of each butterfly blade is rotatable away from each other in a downstream direction from the closed position to the open position.

Item 16. An impeller for a hydraulic rotary drive, the impeller comprising:
a plurality of butterfly blades extending radially away from a rotation axis and circumferentially spaced apart,
each butterfly blade including first and second wings that are rotatable about a radial axis between an open position and a closed position.

Item 17. The impeller of item 15, wherein:
in the open position, each butterfly blade has a first height parallel to the rotation axis, and
in the closed position, each butterfly blade has a second height parallel to the rotation axis and that is less than the first height.

Item 18. The impeller of item 16, wherein:
the second height is less than one quarter of the first height

Item 19. The impeller of any one of items 15-17, wherein:
in the open position, each butterfly blade has a first tangential projection area, and
in the closed position, each butterfly blade has a second tangential projection area that is less than the first tangential projection area.

Item 20. The impeller of item 18, wherein:
the second tangential projection area is less than one quarter the first tangential projection area.

Item 21. The hydraulic rotary drive of any one of items 15-19, further comprising:
a hub that intersects the rotation axis,
wherein each butterfly blade includes an axle extending from a proximal axle portion to a distal axle portion, the proximal axle portion mounted to the hub, and the first and second wings rotatably mounted to the distal axle portion.

1. A hydraulic rotary drive comprising:
a stator having a liquid chamber defining a liquid inlet, a liquid outlet, and a flow circuit extending between the liquid inlet and the liquid outlet; and
an impeller rotatably connected to the stator, the impeller having a plurality of butterfly blades positioned in the flow circuit, and a rotation axis,
wherein each butterfly blade extends radially away from the rotation axis, and includes first and second wings that are rotatable relative to each other about a radial axis between an open position and a closed position.

2. The hydraulic rotary drive of claim 1, wherein:
each of the first and second wings has a liquid drive surface,
in the open position, the liquid drive surfaces of the first and second wings is oriented to promote energy exchange with liquid in the flow circuit, and
in the closed position, the liquid drive surfaces of the first and second wings is oriented to inhibit energy exchange with liquid in the flow circuit.

3. The hydraulic rotary drive of claim 1, wherein:
in the open position, each butterfly blade has a first height parallel to the rotation axis, and
in the closed position, each butterfly blade has a second height parallel to the rotation axis and that is less than the first height.

4. The hydraulic rotary drive of claim 3, wherein:
the second height is less than one quarter of the first height

5. The hydraulic rotary drive of claim 1, wherein:
in the open position, each butterfly blade has a first tangential projection area, and
in the closed position, each butterfly blade has a second tangential projection area that is less than the first tangential projection area.

6. The hydraulic rotary drive of claim 5, wherein:
the second tangential projection area is less than one quarter the first tangential projection area.

7. The hydraulic rotary drive of claim 1, wherein:
the flow circuit has a forward flowpath extending from the liquid inlet to the liquid outlet, and a return flowpath extending from the liquid outlet to the liquid inlet,
measured parallel to the rotation axis, a height of the return flowpath is less than a height of the forward flowpath.

8. The hydraulic rotary drive of claim 1, wherein:
the flow circuit has a forward flowpath extending from the liquid inlet to the liquid outlet, and a return flowpath extending from the liquid outlet to the liquid inlet,
a cross-sectional area of the return flowpath is less than a cross-sectional area of the forward flowpath.

9. The hydraulic rotary drive of claim 1, wherein:
a volume of the return flowpath is less than a volume of the forward flowpath.

10. The hydraulic rotary drive of claim 7, wherein:
the stator includes a plurality of fins that protrude into the return flowpath of the flow circuit.

11. The hydraulic rotary drive of claim 10, wherein:
each fin has a resiliently flexible distal edge.

12. The hydraulic rotary drive of claim 1, wherein:
the impeller includes a hub that intersects the rotation axis, and
each butterfly blade includes an axle extending from a proximal axle portion to a distal axle portion, the proximal axle portion mounted to the hub, and the first and second wings rotatably mounted to the distal axle portion.

13. The hydraulic rotary drive of claim 1, wherein:
the flow circuit is circular and centered around the rotation axis.

14. The hydraulic rotary drive of claim 13, wherein:
the liquid inlet is spaced 180 degrees apart from the liquid outlet.

15. The hydraulic rotary drive of claim 1, wherein:
the first and second wings of each butterfly blade is rotatable away from each other in a downstream direction from the closed position to the open position.

16. An impeller for a hydraulic rotary drive, the impeller comprising:
a plurality of butterfly blades extending radially away from a rotation axis and circumferentially spaced apart,
each butterfly blade including first and second wings that are rotatable about a radial axis between an open position and a closed position.

17. The impeller of claim 16, wherein:
in the open position, each butterfly blade has a first height parallel to the rotation axis, and
in the closed position, each butterfly blade has a second height parallel to the rotation axis and that is less than the first height.

18. The impeller of claim 17, wherein:
the second height is less than one quarter of the first height

19. The impeller of claim 16, wherein:
in the open position, each butterfly blade has a first tangential projection area, and
in the closed position, each butterfly blade has a second tangential projection area that is less than the first tangential projection area.

20. The impeller of claim 19, wherein:
the second tangential projection area is less than one quarter the first tangential projection area.

21. The hydraulic rotary drive of claim 16, further comprising:
a hub that intersects the rotation axis,
wherein each butterfly blade includes an axle extending from a proximal axle portion to a distal axle portion, the proximal axle portion mounted to the hub, and the first and second wings rotatably mounted to the distal axle portion.
